(19) United States
(12) Patent Application Publication
(10) Pub. No.: US 2020/0090881 A1
(43) Pub. Date: Mar. 19, 2020

(54) SMART CIRCUIT BREAKER BOX SYSTEM

(71) Applicants: Brendan G. Fields, Oak Park, IL (US); Michael McGuirk, Boulder, CO (US)

(72) Inventors: Brendan G. Fields, Oak Park, IL (US); Michael McGuirk, Boulder, CO (US)

(21) Appl. No.: 16/573,437

(22) Filed: Sep. 17, 2019

Related U.S. Application Data
(60) Provisional application No. 62/732,725, filed on Sep. 18, 2018.

(51) Int. Cl. H01H 9/54; H02J 3/14; G05F 1/66; H01H 9/16

(52) U.S. Cl. CPC H01H 9/54; H02J 3/14; H01H 2071/006; H01H 9/167; G05F 1/66

(57) ABSTRACT

The invention comprises a smart circuit breaker, system, and method of use. The system comprises a circuit breaker box assembly having at least one breaker switch or panel coupled to a display. The system further having an operating system and graphical user interface configured to identify electrical nodes on branch circuits and organize the electrical nodes corresponding with individual breaker switches or panels and display the organized data through the graphical user interface. Additional aspects of the invention include network communication means configured to relay system data to an external mobile computing device or cloud server. Additional aspects of the invention include the external mobile computing device or cloud server configured to remotely control the functionality of the system and power to each electrical node.

### CROSS-REFERENCE TO RELATED APPLICATIONS

This application claims priority to U.S. Provisional Application No. 62/732,725, filed Sep. 18, 2018, which is hereby incorporated by reference in its entirety.

### BACKGROUND OF THE INVENTION

The present invention generally relates to the field of circuit breakers and circuit breaker box assemblies. More particularly, the invention relates to a smart circuit breaker box assembly comprising enhanced connectivity features over standard circuit breaker box assemblies.

An electrical circuit breaker panel is the main distribution point for electrical circuits in a home or building. The electrical circuit breaker usually provides between 100 and 200 amps of power, depending on the rating of the panel. Power comes to the home or building from the utility company's power lines, flows through an electrical meter, which records electricity usage, and then into the panel. Some systems also have a large disconnect switch between the meter and the panel.

Each individual circuit breaker itself is an automatically operated electrical switch designed to protect an electrical circuit from damage caused by excess current from an overload or short circuit. The breakers basic function is to interrupt current flow after a fault is detected. Unlike a fuse, which operates once and then must be replaced, a circuit breaker can be reset (either manually or automatically) to resume normal operation.

Most circuit breaker panels are arranged in vertical columns within the circuit breaker box and include a main breaker configured to control power to all of the other individual breakers of the panel. The individual breakers aligned in columns are generally considered branch circuits that branch off to control individual or groups of outlets, lighting fixtures, appliances, or similar electrical devices. Typically, circuit breaker box assemblies have a table diagram of the individual breakers placed on the circuit breaker box door. The table diagram allows an installer to label each branch circuit by writing the appliance name or building location within the table.

When building a new house or building, there are two phases of work for an electrician in, the “rough” and “trim” phases. The rough phase accounts for everything that goes behind the drywall. Pipes are run and all wires are connected for the outlets and switches back to the breaker panel. The trim phase is when all fixtures, electrical devices, light switches and outlets are installed.

The process is not without its shortcomings, with excessive man hours spent on both rough and trim phases. In short, too much relies on the electrician and their organizational abilities. It is entirely up to the electrician to keep track of the complex route of wiring, to remember where everything goes and label it accurately on the breaker panel. In some cases, there simply is not enough room on the labels or table diagram to include all loads on a given circuit. Once an electrician leaves a particular job, the precision of that information goes with it. When the electrician returns for the trim phase, or another electrician comes to wire an addition, the electrician must interpret how the diagram is labeled to appropriately add new wiring. Lost or inaccurate information may lead to inefficient installs and costly repairs. Because of these shortcomings, virtually every home has some incorrect information on its electrical panel. Most homeowners just stay away from their breaker box, in fear of doing more harm than good.

The present invention attempts to overcome the shortcomings of the electrical circuit breaker panels and box assemblies of the prior art by providing a smart circuit breaker assembly configured to communicate with active devices and nodes while providing an electronic organizable circuit breaker panel table interface such that complete descriptions of breaker loads for individual breakers can easily be stored and determined.

### SUMMARY OF THE INVENTION

In view of the above, a smart circuit breaker assembly configured to communicate with connected electrical devices and provide a graphical user interface detailing the electrical devices and layout within the breaker panel is provided. The advantage of the present invention is that it allows contractors, electricians, homeowners and building maintenance managers easy access to the electrical layout of the home or building to manage electrical devices, provider repairs, or provide updates to the existing infrastructure. It is to be understood by one of skill in the art that the term “electrical node” in this present specification is used to define an electrical device including but not limited to appliances, fixtures, outlets, and junctions boxes.

In one embodiment of the invention, the electrical circuit breaker system comprises an electrical circuit breaker box, at least one electrical circuit breaker or circuit breaker panel disposed within the electrical circuit breaker box, an external display unit, and a graphical user interface. In some embodiments, the graphical user interface is accessible through a display unit coupled to the electrical circuit breaker box. In these embodiments, the display unit may comprise or may be coupled to a microprocessor, memory, and power supply such that it is a stand-alone computing device or the electrical circuit breaker box assembly may comprise a microprocessor, memory, and a display unit such that the display is electrically integrated into the circuit breaker box. Some embodiments may additionally comprise a backup power supply such as a battery or generator configured to power the breaker system and display unit.

In other aspects of the system, the electrical circuit breaker box further comprises, a means for external communication including but not limited to Powerline, Ethernet, USB, Wi-Fi, Bluetooth, NFC, cellular radio, LoRa, ZWAVE, and ZIGBEE within the electrical circuit breaker. In these embodiments, the graphical user interface may be installed or accessed on an external computing such as a mobile phone or a cloud server in active communication with the electrical circuit breaker box.

In the above mentioned embodiments, the graphical user interface may visually represent the layout of the circuit breaker panel. The user may select individual breakers and manually input all electrical nodes connected to the particular individual breaker. The user may then save the inputted data into a breaker database that is accessible through the graphical user interface at a later time. In embodiments having a means for external communication, the user may export the breaker layout database to third parties or merely provide a backup copy for themselves. The exported database may include but is not limited to an image of a network map or a CSV or similar file to be imported into common spreadsheet or database applications.

In additional aspects of the system having a means for external communication, the system may be configured to communicate directly with electrical nodes having an electrical node communication means connected to the system. In these embodiments the system may be configured to communicate with the connected electrical nodes to populate the circuit breaker layout database and provide information about the electrical node to the system. In operation a user would place a particular individual breaker or group of breakers in an “Install Mode” or “Remodel Mode” configured to detect the presence of an individual electrical node or group of electrical nodes installed within the branch circuit controlled by each breaker. In some embodiments, each electrical node will identify itself and the system will populate the breaker database according to the individual breaker that the node is connected to. In other embodiments, the user may manually identify the electrical nodes one at a time and manually input the node information into the breaker database through the graphical user interface.

In additional aspects of the system, the electrical nodes or the individual breakers or branch circuits may be configured with smart sensors including but not limited to current sensors and temperature sensors. In these embodiments, the system is configured to actively report available sensor data through the graphical user interface, or other means including but not limited to email or text messaging, providing the user with data regarding node current use, system load, and whether one of the individual circuit breaker switches have been tripped. The system may be additionally configured to allow the user to selectively depower individual nodes or entire branch circuits through the graphical user interface.

In other aspects of the system, the individual circuit breaker may be mechanized and configured to be tripped or reset through the graphical user interface. In these embodiments, the mechanization device may be independently powered from the individual circuit breaker switch and configured to change switch positions upon receiving communication through the system from the user through the graphical user interface.

The methods, systems, apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is understood that both the foregoing general description and the following detailed description are exemplary and explanatory only and are not restrictive of the methods, apparatuses, and systems, as claimed.

### BRIEF DESCRIPTION OF THE DRAWINGS

In the accompanying figures, like elements are identified by like reference numerals among the several preferred embodiments of the present invention.

FIG. 1 is a representation of an embodiment of the system

FIG. 2 is a representation of an additional embodiment of the system.

FIG. 3 is a map diagram view of an embodiment of the system.

FIG. 4 is an exploded view of a component of the system.

FIGS. 5A-B are representations of the graphical user interface of the system.

FIGS. 6A-B are flow charts representing embodiments of system operation.

FIG. 7 is an exploded view of an embodiment of the system having inline measurement sensors.

Other aspects and advantages of the present invention will become apparent upon consideration of the following detailed description, wherein similar structures have similar reference numerals.

### DETAILED DESCRIPTION OF THE PREFERRED EMBODIMENTS

The foregoing and other features and advantages of the invention will become more apparent from the following detailed description of exemplary embodiments, read in conjunction with the accompanying drawings. The detailed description and drawings are merely illustrative of the invention rather than limiting, the scope of the invention being defined by the appended claims and equivalents thereof.

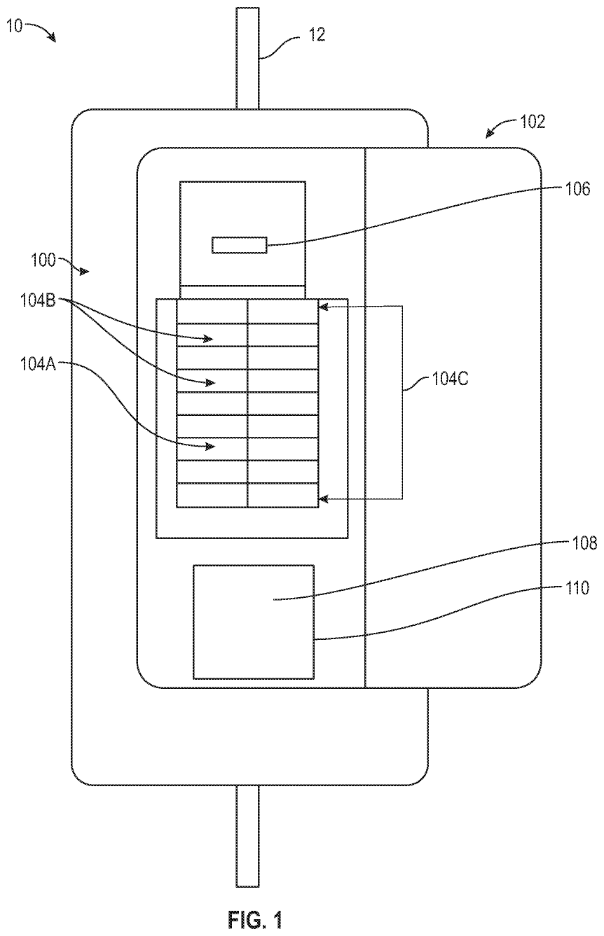

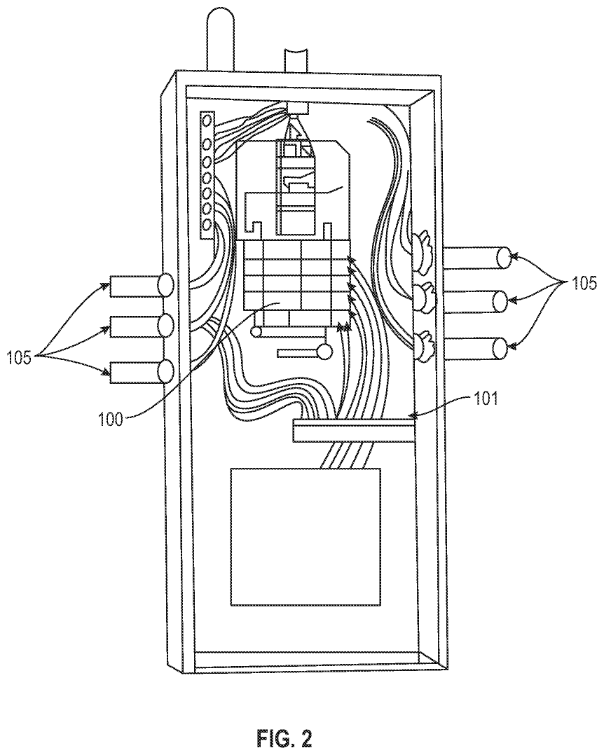

With reference to FIGS. 1-3, the electrical circuit breaker system 10 comprises a primary electrical source 12 coupled to an electrical circuit breaker box 100, with optional door 102, at least one electrical circuit breaker 104A, plurality of electrical circuit breakers 104B, or panels of electrical breakers 104C forming branch circuits 105 and optional main shut off breaker 106, disposed within the electrical circuit breaker box 100, and graphical user interface 108. In some embodiments, the graphical user interface 108 is accessible through a display unit 110 coupled to the electrical circuit breaker box 100. In these embodiments, the display unit 110 may comprise a microprocessor, memory, and power supply such that it is a stand-alone computing device or as shown in FIG. 2, the electrical circuit breaker box 100 may comprise a microprocessor, memory, and a display unit connection such that the display is electrically coupled 101 to the circuit breaker box 100. Some embodiments may additionally comprise a backup power supply (not shown) such as a battery or generator configured to power the breaker system 10 and display unit 110. It is to be understood by one of skill in the art, that the term “graphical user interface,” in this specification can be used to describe the system 10 operating system itself or the front end user interface for the system 10 operating system.

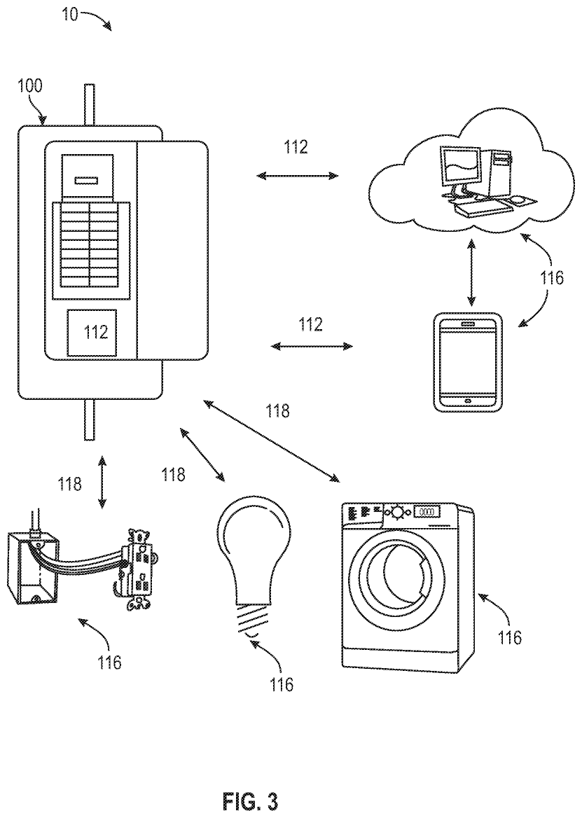

As shown in FIG. 3, the electrical circuit breaker box 100 further comprises, a means for communication 112 including but not limited to Powerline, Ethernet, USB, Wi-Fi, Bluetooth, NFC, cellular radio, ZWAVE, and ZIGBEE, wherein the electrical circuit breaker. In these embodiments, the graphical user interface may be installed on an external computing device 114 such as mobile phone or a cloud server in active communication with the electrical circuit breaker box 100 and electrical nodes 116 active within the system 10.

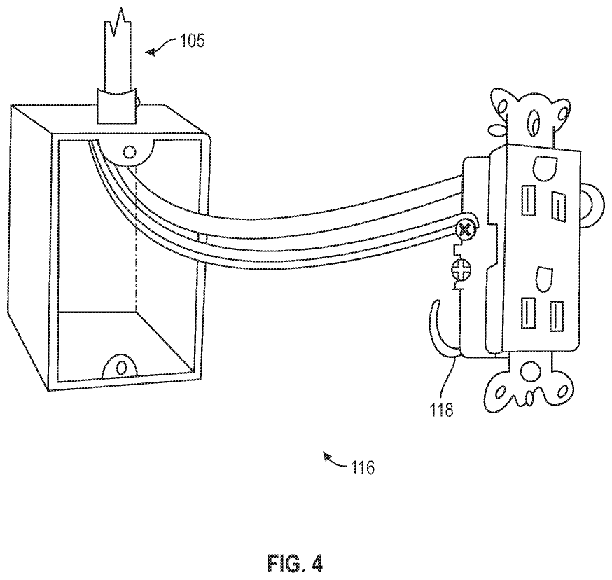

FIG. 4 shows an exploded view of an example electrical node 116 having an electrical node communications means 118 similar to the communication means 112 as described above configured to communicate with the system graphical user interface 108. The electrical node 116 is further coupled to a branch circuit 105 and controlled by circuit breaker 104.

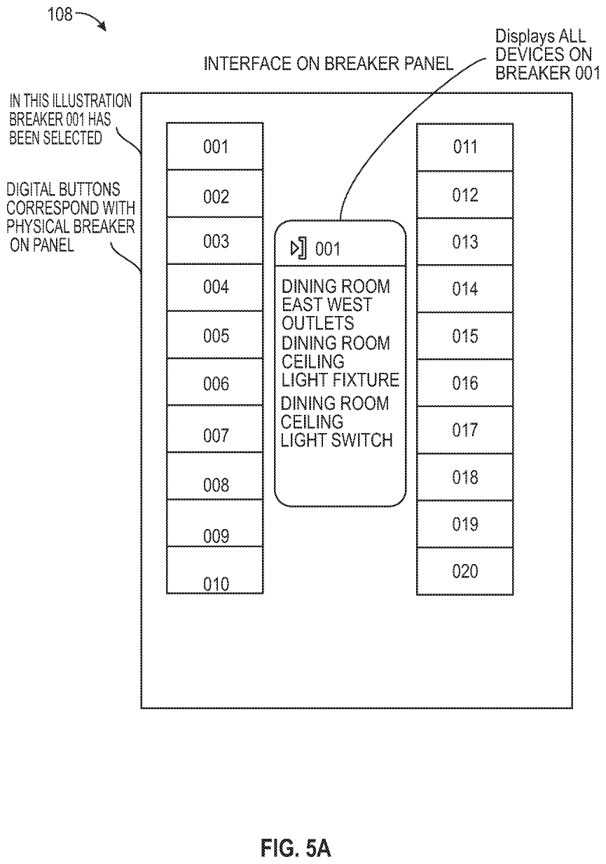

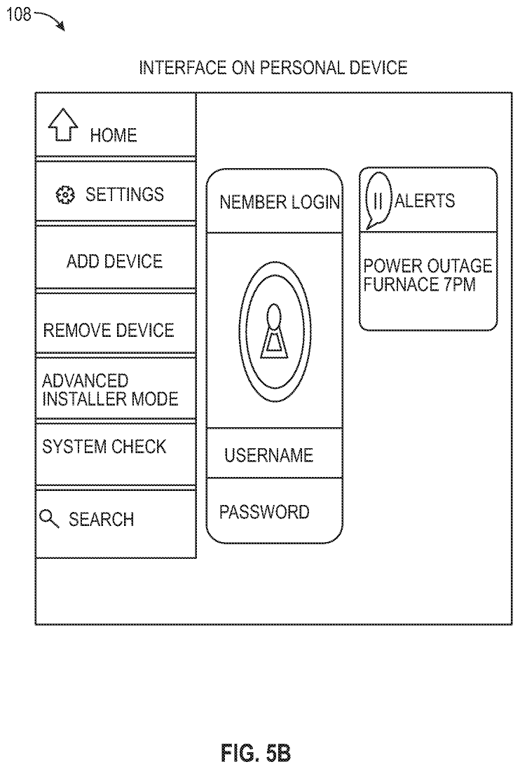

As shown in FIGS. 5A-5B the graphical user interface 108 in some embodiments may visually represent the layout of the circuit breaker panel 104C. The user may select individual breakers 104A and manually input all electrical nodes 116 connected to the particular individual breaker 104A through the individual branch circuit 105. The user may then save the inputted data into a breaker database stored on the memory that is accessible through the graphical user interface 108 at a later time. In embodiments having communication means 112, the user may export the breaker layout database to the external computing device 114.

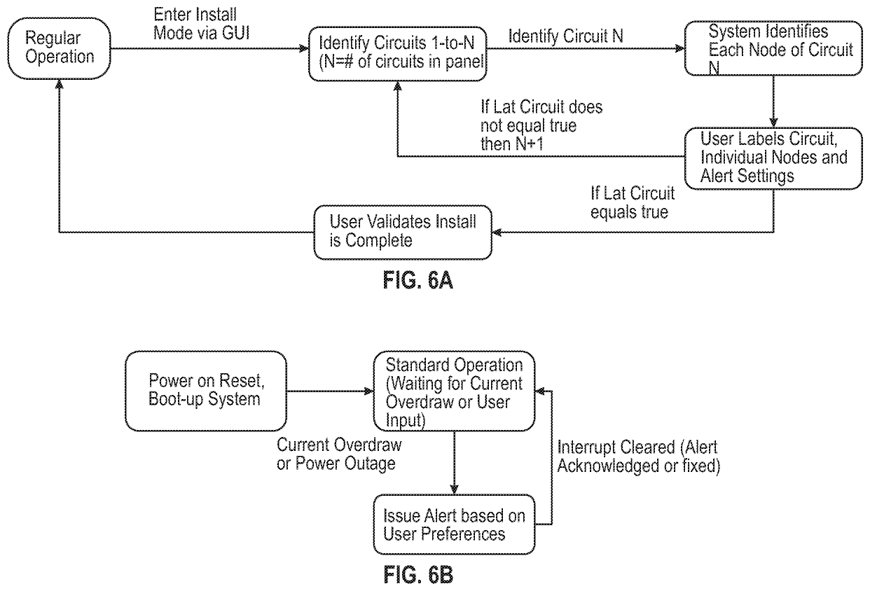

As show operational flows chart of FIGS. 6A-6B of the system 10 having a communication means 112, the system 10 may be configured to communicate directly with electrical nodes 116 having an electrical node communication means 118 connected to the system. In these embodiments the system 10 may be configured to communicate with the connected electrical nodes 116 to populate the circuit breaker layout database and provide information about the electrical node 116 to the system 10. As shown in FIG. 6A in operation a user would place a particular individual breaker 104A or group of breakers 104B, 104C in an “Install Mode” or “Remodel Mode” configured to detect the presence of an individual electrical node 116 or group of electrical nodes 116 and identify the individual electrical node 116 or group of electrical nodes 116 installed within the branch circuit 105 controlled by each breaker 104A. In some embodiments, each electrical node 116 will identify itself or broadcast its presence through the electrical node communication means 118 to the system 10 and the system 10 through the population subroutine will populate the breaker database according to the individual breaker 104A that the node 116 is connected to. In other embodiments as shown in FIG. 6A the user may manually identify the electrical nodes 116 one at a time and manually input the node 116 information into the breaker database through the graphical user interface 108. Upon the user entering the last circuit, or the system 10 timing out and not detecting additional circuits, the user validates that the install or remodel is complete.

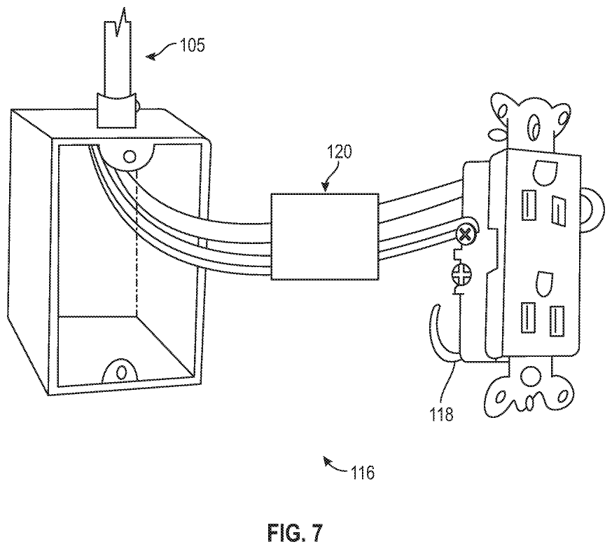

In additional embodiments, as shown in FIG. 6B and FIG. 7, the electrical nodes 116 or the individual breakers 104A or branch circuits 105 may be configured with smart sensors 120 including but not limited to current sensors and temperature sensors. In these embodiments, as shown in FIG. 6B, the system 10 is configured with a data collection subroutine configured to collect data from the sensors and to actively report the available sensor data through the graphical user interface 108, or other means including but not limited to email or text messaging. The alerts may provide the user with data regarding node 116 current use, system 10 load, and whether any of the individual circuit breakers 104A have been tripped. The system 10 may be additionally configured to allow the user to selectively depower individual nodes 116 or entire branch circuits 105 through a power management subroutine accessible via the graphical user interface 108.

In some embodiments, the individual circuit breakers 104A may be mechanized and configured to be tripped or reset through the power management subroutine accessible through the graphical user interface 108. In these embodiments, the mechanization device may be powered independently powered from the individual circuit breaker 104A and configured to change switch positions upon receiving communication through the system 10 from the power management subroutine through the graphical user interface 108.

Those of ordinary skill in the art will understand and appreciate the aforementioned description of the invention has been made with reference to certain exemplary embodiments of the invention, which describe a smart circuit breaker system and method of use. Those of skill in the art will understand that obvious variations in construction, material, dimensions or properties may be made without departing from the scope of the invention which is intended to be limited only by the claims appended hereto

1. An electrical circuit breaker system comprising:
an electrical circuit breaker box configured to receive a primary electrical source;
at least one electrical circuit breaker disposed within the electrical circuit breaker box and coupled to the primary electrical source, the at least one electrical circuit breaker configured to form at least one branch circuit coupled to at least one electrical node;
a display unit coupled to the electrical circuit breaker box and coupled to a power supply, a microprocessor, and memory; and
a graphical user interface configured to execute on the display unit wherein the graphical user interface displays a database having a table configured to represent a physical layout of the at least one electrical circuit breaker and the at least one electrical node coupled to the at least one electrical circuit breaker.

2. The electrical circuit breaker system of claim 1 wherein the display unit is further coupled to a communication means.

3. The electrical circuit breaker system of claim 2 wherein the at least one electrical node is communicatively coupled through the communication means to the graphical user interface and the graphical user interface is configured to identify the electrical node and populate the electrical node into the database and display the electrical node in the table through the display unit.

4. The electrical circuit breaker system of claim 3 wherein the graphical user interface is configured to communicate an electrical circuit breaker or electrical node status through the communication means to an external computing device.

5. The electrical circuit breaker system of claim 3 wherein the at least one electrical node or branch circuit is further coupled to a measurement sensor communicatively coupled to the graphical user interface and the graphical user interface is configured to monitor the measurement sensor and report collected measurement data through the display unit or to an external computing device.
